(19) United States
(12) Patent Application Publication
(10) Pub. No.: US 2019/0297798 A1
(43) Pub. Date: Oct. 3, 2019

(54) Method and Apparatus for Networked Irrigation Controllers that Adjust Watering Schedules in Response to Rainfall

(71) Applicants: Michael R. Levine, Boca Raton, FL (US); Harold Davis, Coral Springs, FL (US)

(72) Inventors: Michael R. Levine, Boca Raton, FL (US); Harold Davis, Coral Springs, FL (US)

(21) Appl. No.: 16/430,830

(22) Filed: Jun. 4, 2019

Related U.S. Application Data
(63) Continuation-in-part of application No. 15/851,955, filed on Dec. 22, 2017, now Pat. No. 10,306,844.

(51) Int. Cl. A01G 25/16; G05B 13/02; G01W 1/00; G06F 9/54; H04W 52/02

(52) U.S. Cl. CPC A01G 25/165; G05B 13/026; H04W 52/0251; G06F 9/542; H04W 52/0216; G01W 1/00

(57) ABSTRACT

A method and apparatus for a battery powered networked irrigation controller that communicates with a backend server to implement updated watering schedules as needed, rather than the irrigation controller waiting until the next scheduled watering event of the obsolete watering schedule. A local wireless network transceiver can be accessed locally by a mobile device to prompt the irrigation controller to wake up from a sleep mode and communicate with the backend server to verify or obtain the updated watering schedule, allowing for changes in the horticultural conditions in the region watered by the irrigation controller, such as the laying of new sod.

### CROSS REFERENCE

This application is a continuation in part of U.S. patent application Ser. No. 15/851,955, filed Dec. 22, 2017, having the title “Method and Apparatus for Networked Irrigation Controllers That Adjust Watering Schedules in Response to Rainfall,” and attorney docket no. LEV2017001US1, the entirety of which is hereby incorporated by reference.

### FIELD OF THE DISCLOSURE

The present disclosure relates generally to irrigation control, and more particularly to adjusting a schedule in real time in a remotely located wirelessly networked irrigation controller that is configured to remain in a sleep mode until a scheduled watering time.

### BACKGROUND

There are a wide variety of applications in which irrigation control is used to ensure optimum watering of crops and landscaping. In general, irrigation is used to supplement natural rainfall, but frequently it is used in addition to rainfall, often leading to overwatering and therefore wasteful watering. The conservation of water supplies is of paramount concern, so it is of interest to not water when natural rainfall has occurred sufficient to meet the watering needs of a region for a given period.

Many manufacturers have designed systems that inhibit watering upon the occurrence of rain by using local sensors that measure rainfall or soil moisture. However these systems are prone to inaccurate readings and breakage of the sensor equipment. Furthermore, irrigation controllers typically require a commercial electric power source because of the frequent operation of circuitry. This limits the ease of deployment of irrigation controllers, or adds to the cost by requiring the laying of power lines to areas to be serviced by irrigation controllers. Wireless irrigation controllers have been designed that are exclusively battery powered, and save power the controller, or at least the wireless modem/transceiver, is placed into a sleep mode until it is time to water. This presents a problem when the horticultural state of the area being watered by the controller changes. For example, if new sod is placed, which needs to be watered more frequently than established grass, then several days may go by under the programmed schedule, before the controller wakes up the wireless networked transceiver to contact a scheduling server or equivalent entity to receive an updated watering schedule. Accordingly, there is a need to address the problems associated with existing wireless irrigation controllers.

### BRIEF DESCRIPTION OF THE FIGURES

In the accompanying figures like reference numerals refer to identical or functionally similar elements throughout the separate views, together with the detailed description below, and are incorporated in and form part of the specification to further illustrate embodiments of concepts that include the claimed invention and explain various principles and advantages of those embodiments.

FIG. 1 is a deployment diagram for a battery powered networked irrigation controller, in accordance with some embodiments;

FIG. 2 is a block schematic diagram of a battery powered networked irrigation controller, in accordance with some embodiments;

FIG. 3 is a system diagram of a networked irrigation system, in accordance with some embodiments;

FIG. 4 is sequence diagram of an interface sequence operated on a mobile device for interfacing and controlling operation of one or more battery powered networked irrigation controllers, in accordance with some embodiments;

FIG. 5 is a flow chart diagram for a method of operating a battery powered networked irrigation controller, in accordance with some embodiments;

FIG. 6 is a scenario diagram showing several exemplary modes of operation of a battery powered networked irrigation controller, in accordance with some embodiments;

FIG. 7 is an interface diagram showing an month-view of historical operation of a battery powered networked irrigation controller, in accordance with some embodiments;

FIGS. 8-13 show various examples of alert messages and command interfaces for interacting with a networked irrigation system, in accordance with some embodiments;

FIG. 14 shows an irrigation system in which an irrigation controller in low power mode can be reprogrammed prior to its next scheduled wake up time, in accordance with some embodiments; and

FIG. 15 is a signal flow diagram showing examples of methods for reprogramming a wireless irrigation controller that normally operates in a sleep mode until a scheduled watering time, in accordance with some embodiments.

Those skilled in the field of the present disclosure will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. The details of well-known elements, structure, or processes that would be necessary to practice the embodiments, and that would be well known to those of skill in the art, are not necessarily shown and should be assumed to be present unless otherwise indicated.

### DETAILED DESCRIPTION

[Summary paragraph reflecting one or more independent claims—to be written after first review and feedback]

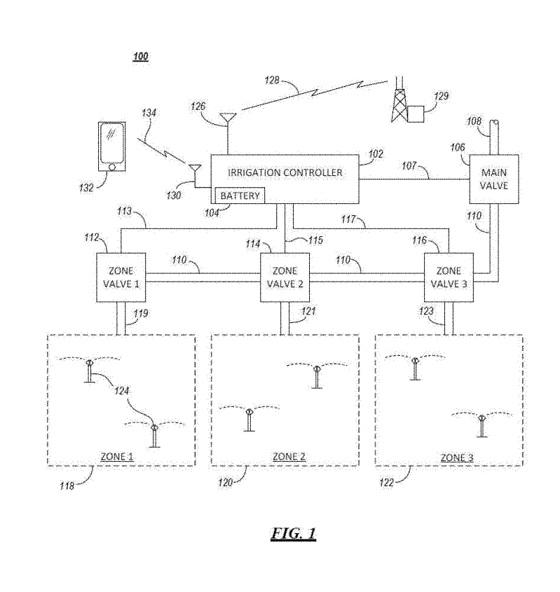

FIG. 1 is a deployment diagram 100 for a battery powered networked irrigation controller 102, in accordance with some embodiments. The irrigation controller is exclusively powered by a battery 104, which can be either a primary (non-rechargeable) or a secondary (rechargeable) battery. If a secondary battery is used, it can be recharged by a charging means (not shown) such as, for example, a solar to electric conversion unit, or a wind or water turbine generator. The irrigation controller is not powered by a commercial alternating current (AC) electric power source. By being free of a commercial AC source, the time and expense of routing wiring to the irrigation controller 102 is avoided, which can greatly simplify deployment of such irrigation controllers. The irrigation controller 102 controls irrigation or sprinkling operation in one or more nearby areas, referred to as zones, by opening and closing water valves according to a schedule or program set by a remote server that takes natural rainfall into account to avoid watering when rainfall has provided sufficient water.

Accordingly, to control watering, in some embodiments the irrigation controller can control a main valve 106 that is connected to a water source 108, such as, for example, a municipal water supply. The main valve controls the flow of water from the water source 108 to a distribution pipeline 110, which provides water to several zone valves 112, 114, 116, each of which are also controlled by the irrigation controller 102 via respective control lines 113, 115, 117. Each zone valve 112, 114, 116 controls irrigation within a respective zone 118, 120, 122, and is either opened and closed typically by a solenoid-controlled valve mechanism in each zone valve 112, 115, 116. Each zone is a geographic area that can have an arbitrary shape, although the zones are generally contiguous with, or adjacent each other. Each zone 118, 120, 122 contains one or more water distribution outlets 124 that project water over an area within the zone, and are connected to the zone valve 112, 114, 116 through respective zone piping 119, 121, 123. The water distribution outlets can be, for example, sprinkler heads, spray nozzles, and the like. The water distribution outlets 124 are connected to the distribution pipeline 110 through the corresponding zone valve 112, 114, 116 for the respective zone 118, 120, 122.

In general, the irrigation controller 102 enables watering in one zone at a time, according to a prescribed adjustable program, for a selected period of time. The frequency and duration of irrigation depends on the plant matter being watered. For example, many lawns are planted with particular grass types, and in soil such that watering once every several days is sufficient to keep the grass in good condition, once it is established. Zones are generally enabled, and then disabled, in series. So, for example, a typical watering program could be that zone 1 118 is enabled for 30 minutes of watering, and then disabled. Shortly after watering in zone 1 118 is disabled, then watering in zone 2 120 is then enabled for another 30 minutes, and so on, until all zones have been watered for their respective prescribed duration. Watering can be controlled to occur once every “n” days, where n is an integer from 1 to 7, in some embodiments. However, the scheduled, or programmed watering can be shifted by n−r days, when rainfall occurs, where “r” is the number of days since it last rained at the location of the irrigation controller. When rainfall is predicted to occur (with sufficient certainty) on a day on which watering is set to occur, r can be set to zero, and the next watering can then be set to occur in another n days.

Programming of the irrigation controller 102 occurs via radio networking, which can be accomplished by any of several ways. For example, the irrigation controller can include a cellular modem that transmits and receives radio signals via a cellular antenna 126. A cellular modem is a radio modem designed to operate according to any one of several well-known cellular telephony data communication protocols, such as, for example, Long Term Evolution (LTE) as standardized by the 3rd Generation Partnership Project (3GPP), as is well known. Signals can be sent and received over a cellular radio channel 128 established with a cellular base site 129, which is further connected to a cellular infrastructure system, and to other networks, including the Internet, which allows the irrigation controller 102 to communicate with a server and/or other entities connected to the Internet. Similarly, local access can be provided using a local wireless network connection by a wireless network interface circuit using a local wireless antenna 130. A local wireless radio link 134 can connect the irrigation controller to a nearby device 132, such as a tablet computer, laptop computer, or cellular phone device. The local wireless radio link can be established in accordance with any one of several known short range wireless networking protocols, including those described in Specifications 802.11 and 802.15 of the Institute of Electrical and Electronics Engineers (IEEE), which include those protocols known as “WiFi” and “BlueTooth.” Local wireless access allows groundskeepers, residents, and others to locally configure and operate the irrigation controller. Of course, as an alternative to a local wireless interface, a wired interface (e.g. Universal Serial Bus) can be used instead.

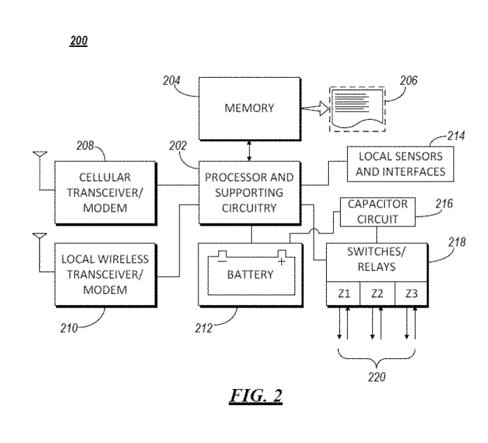

FIG. 2 is a block schematic diagram of a battery powered networked irrigation controller 200, in accordance with some embodiments. Accordingly, the irrigation controller is connected to a battery 212 that provides power to the irrigation controller 200. The battery can be a primary or a secondary battery, depending on the application. By being battery powered, there is no need for a typical connection to commercial electric AC power, which greatly simplifies the deployment of irrigation controllers. In general, the irrigation controller 200 controls irrigation or sprinkling operation of one or more zones according to a program or schedule it receives via a radio network from a server. The irrigation controller 200 can be set to water once every several days, where the number of days is fixed, as a default. The server determines rainfall in the particular region where the irrigation controller 200 is located, and when rainfall occurs, it messages the irrigation controller 200 to shift its watering pattern so that the next watering day occurs that same several days after the last rainfall. That is, the watering schedule is agnostic with respect to dates, and instead ensures that there are no more than a selected maximum number of non-watering days between watering days, whether the watering occurs naturally (e.g. rain), or by the irrigation controller 200.

The irrigation controller 200 includes a processor unit 202 that comprises one or more microprocessors and supporting circuity (e.g. frequency clock, time/date clock, voltage regulation, interface). The microprocessor unit is coupled to memory 204, which, as shown here, is an abstraction that can represent several different forms of memory in aggregate, which can include, for example, read only memory (ROM), random access memory (RAM), flash memory, and so on. Each different type of memory including in aggregate memory 204 is separately addressable by the one or more microprocessors in the microprocessor unit 202. The memory 204 includes at least one non-volatile memory unit and one RAM memory unit. The non-volatile memory unit can be used to store instruction code, records, files, and the like, including data acquired during operation, logs, and the like. In particular, a file 206 is maintained that indicates scheduled watering events, and the days on which they are to be carried out. The file 206 is a dynamically maintained data structure or record that changes and is updated as operations commence, and can indicate, among other information, the next day on which watering is to occur.

The instruction code stored in memory 204 is executed or performed by the one or more microprocessors in the microprocessor unit 202 to carry out functionality to be described herein, including control of zone valves, control of a main valve, communications with a remote server, communications with a locally connected device, and so on.

To facilitate communications with a remote server (or other similar remote equipment), the irrigation controller 200 includes a wide area radio network transceiver such as a cellular transceiver modem 208. The cellular transceiver modem 208, or simply cellular modem, can access a cellular telephony network using a known air interface such as the LTE air interface to engage in data communications with a remote server. The remote server (not shown) determines whether rainfall has occurred at the location of the irrigation controller, and can command the irrigation controller to shift its watering program when rainfall has occurred.

To conserve battery charge, the cellular transceiver modem is maintained in an off state by the microprocessor unit 202 until, according to its time/date clock, and turned on when it is time to commence watering, or just prior to commencing watering. Once turned on the irrigation controller uses the cellular transceiver modem 208 to communicate with the remote server. In the communication the irrigation controller 200 can communicate any information it may have, such as battery status (e.g. charge state, any faults, recharge cycles), programming changes made locally, maintenance activity, and so on. The remote server, in response to the communication, can send information regarding whether the irrigation controller 200 is to commence watering as scheduled, or to shift the schedule due to recent or predicted rainfall (e.g. to occur later the same day). If the server indicates no rainfall has occurred since the last watering, the irrigation controller will then commence its scheduled watering program. Otherwise, the irrigation controller will not commence watering and instead select the next day to commence watering based on the recency of the rainfall and the number of non-watering days set to pass between watering days. Once communication is completed, the cellular transceiver modem is turned off again until the next scheduled watering event.

Similarly, the irrigation controller 200 can include a local wireless transceiver 210 to facilitate local access, and which can operate using any of the known low power, short range wireless networking protocols, such as those described in specifications IEEE 802.11 or IEEE 802.15. Local access allows people (e.g. maintenance personnel) to adjust or control operation of the irrigation controller 200 while present in the vicinity of the irrigation controller 200 in order to conduct maintenance operations, tests, reconfiguration, and so on, as well as to cause the irrigation controller 200 to wake up and download or verify an updated watering schedule for special watering conditions. A handheld device such as a tablet or mobile phone device can run an application program using a similar short range wireless network transceiver to connect with the irrigation controller 200 via the local wireless transceiver 210, and input and export information, including schedule changes, as well as override present schedules to conduct the maintenance operations.

The irrigation controller further includes a battery 212 that is used to power, exclusively, the irrigation controller 200 and circuitry associated circuitry. The battery 212 can represent one or more battery cells organized in any of several configurations. The battery 212 can be a rechargeable battery or a primary battery, and when the battery 212 is a rechargeable battery the battery 212 can be recharged by, for example, an external solar cell array and associated charge regulation circuitry, as is well known. The battery can also be recharged using other renewable energy sources such as wind or water powered generators.

The irrigation controller 200 can further include local sensors and interfaces 214. Local sensors can include, for example, a moisture sensor, a temperature sensor, a rain gauge, among other sensors for measuring conditions at the location of the irrigation controller 200 that are relevant to determining whether watering is needed. The data produced by such sensors, when used, can be used by the processor circuit 202 and software, as well as being reported to a remote server via the cellular transceiver 208. Local interfaces can include, for example, a universal serial bus (USB) connector to allow a wired connection to the irrigation controller 200 in lieu of, or in addition to, the local wireless transceiver 210 being present.

The irrigation controller 200 provides watering by scheduled operation of valves which allow water to flow through the piping and water distribution devices (e.g. sprinkler heads). Typically there can be a main valve, as well as several zone valves. Each valve is operated by a switch or relay of a set of switches 218. Here, three switches are shown, one for each of zones Z1, Z2, Z3. The switches each provide a current pulse to a solenoid of their respective valve that controls opening and closing of the valve over respective electrical wiring lines 220. The current is sourced from the battery 212, and the valves operate by switching state (open or closed) in response to a current pulse, which obviates the need for a continuous flow of current to maintain the valve open. To avoid a condition where a valve is opened, and the battery then becomes depleted while the valve is open, and unable to source enough current to shut off the valve, a capacitor circuit 216 is used to store charge sufficient to ensure that the valves can be closed. Given that the battery would have to be in a very low charge state for this to occur, the irrigation controller 200 will report the low battery charge state to the remote server upon waking up the cellular transceiver modem 208 to check in with the remote server and verify that it is time to commence watering.

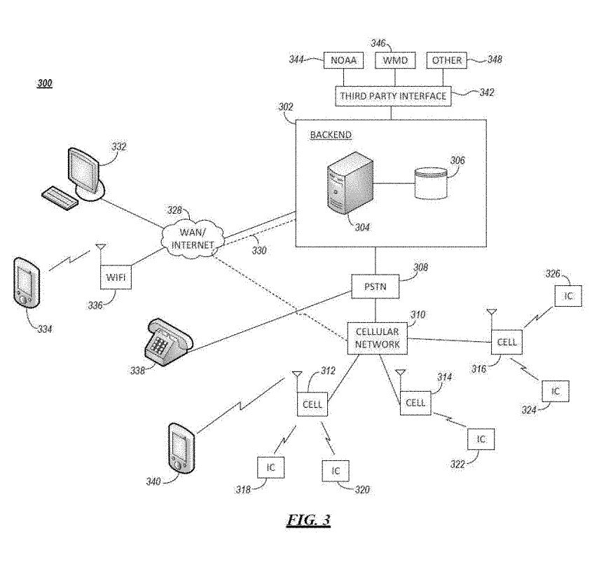

FIG. 3 is a system diagram of a networked irrigation system 300, in accordance with some embodiments. The networked irrigation system 300 links deployed irrigation controllers (e.g. irrigation controllers 318, 320, 322, 324, 326) and other devices with a backend server 302 to facilitate moderating the operation of irrigation controllers 318-326 based on weather and user input. Each irrigation controller 318-326 can be designed in accordance with irrigation controller 200 of FIG. 2. Accordingly, the backend server 302 includes one or more server computers 304 that are coupled to one or more data stores 306. The server computers 304 run software that allows users to configure the desired operation of each deployed irrigation controller 318-326, and moderates their operation based on input received regarding rainfall at the locations of each irrigation controller 318-326. The backend server 302 maintains information in the data store 306 for each irrigation controller 318-326 (e.g. schedule 206 of FIG. 2), including its location (e.g. in latitude and longitude coordinates), the number of zones, and watering schedule (e.g. which days, and duration), among other information.

The backend server 302 can be connected with the irrigation controllers 318-326 over a network infrastructure, such as by using data communications over a public switched telephone network (PSTN) 308 coupled to a cellular network 310. The cellular network includes a plurality of cellular base stations 312, 314, 316. Each base station establishes a “cell” around it to facilitate radio communication according to a standardized signaling and radio protocol, as is well known. Alternatively, the backend server 302 can connect to the cellular network 310 via a wide area network 328, such as the internet, via a data link 330. The data link 330 can be a session established according to transfer control protocol (TCP) and internet protocol (IP) standards. The data link 330 can be established as a virtual private network (VPN) for security purposes. Those skilled in the art will appreciate that the backend server 302 can be connected to several cellular networks like cellular network 310, and provide substantially equivalent service across other cellular networks. In fact the choice of cellular network is driven by the irrigation controllers 318-326, and depends on which cellular network the irrigation controller is subscribed.

Each irrigation controller 318-326, having a cellular transceiver operated as described in accordance with FIG. 2, individually connects to the backend server 302 through the cellular network 310 and any intermediate network or other communication system between the cellular network 310 and the backend server 302. In normal operation, when it is time to commence watering, according to the schedule maintained locally at each irrigation controller 318-326, the irrigation controllers 318-326 will wake up their respective cellular transceiver modems and connect to the backend server 302 to report any status updates or changes, and to verify that watering is to be performed as scheduled, and if not (e.g. due to rainfall) then the next day on which watering is to commence. In some embodiments each time the irrigation controllers 318-326 communicate with the backend server 302 they can provide status updates including a battery status.

To interact with the backend server 302, such as to set up or modify accounts, create or modify records for individual irrigation controllers, and see operational history of irrigation controllers, among other things, various client devices such as a computer 332, mobile devices 334, 340, or a telephone 338 can be used to connect to the backend server 302. The computer 332 can connect using the wide area network 328. The computer 332 can be served web pages generated by the backend server 302 that are viewable using a web browser such as those known by the trade names Firefox, Chrome, Internet Explorer, Opera, and so on. The web pages can be in a markup language such as hypertext markup language (HTML), which is rendered locally by the browser at the computer 332. Similarly, mobile devices 334, 340 can use browser applications designed for mobile devices. Mobile device 334 is shown connecting via a WiFi access point 336, which is connected to the wide area network/Internet 328. Mobile device 340 is shown using a data channel of a cellular base station 312 in the same way as each of the cellular transceivers of the irrigation controllers 318-326 to connect to the backend server 302. However, mobile device 340 uses a browser to access a customer or client-facing portal or page served by the backend server 302 using a specific URL, like the computer 332 and mobile device 334, whereas the irrigation controllers 318-326 can access the backend server 302 using different URLs that interface with applications being run by the backend server 302 which are not optimized for human viewing, but rather optimized for data communication between machines.

A voice line phone access modality can be supported to allow users to access the backend server 310 using a touch tone telephone 338. By calling a specific phone number for the backend server 302, a user can reach a voice interface where the backend server 302 presents a voice menu that allows the user to select from one or more options to navigate through a set of nested voice menus, as is well known. As with using a web browser on computer 332, or mobile devices 334, 340, a user can check on the status of a given irrigation controller, set up (provision), or delete an irrigation controller. For example, upon calling from the phone 338, the caller can be prompted to enter an account number using the touch tone buttons. The tones produced by the phone 338 are decoded by a voice interface application of the backend server 302 to access the corresponding account information. Each account can include one or more irrigation controllers that each have their own unique identifier. By entering the identifier of an irrigation controller the caller can access a voice menu that allows the caller to provision the irrigation controller, such as by selecting a default number of days between watering, and adjusting each zone operated by the irrigation controller to, for example, water normally, water more often than normally for a number of days (e.g. when sod is placed in the zone), suspend watering in a zone for a number of days, and so on.

In addition to the computer 332, mobile devices, 334, 340, and telephone 338, other modalities of accessing the backend server 302 can be operated equivalently. Each of these access modalities facilitate access to the user's account information, as well as interfaces that allow for setting up and controlling the operation of the user's irrigation controllers, obviating the need to dispatch personnel to each irrigation controller and access the irrigation controller directly. The information and settings established by users upon accessing interfaces presented by the backend server 302 are stored by the backend server 302, such as in data sore 306, in association with a record for each irrigation controller. When the irrigation controllers 318-326 contact the backend server 302, the backend server 302 can respond with updated settings information to modify operation of an irrigation controller if the user/owner of the irrigation controller has provided updated information. Furthermore, the historical operation of each irrigation controller, including any alert messages and other status events, can be presented to users by the backend server 302 in appropriate interfaces provided by the backend server 302.

One of the operations of the irrigation controllers 318-326 that can be adjusted is scheduled watering days. The backend server 302 uses an interface 342 to access weather resources, such as the National Oceanic and Atmospheric Administration (NOAA) 344, an open weather site such as WMD-Weather 346, or other 348 resources with weather information. The weather information for each of these sites 344, 346, 348 indicates historical as well as predicted rainfall information for specific geographic locations. Each day the backend server 302 can access these resources to determine if rain has fallen (and the amount of precipitation), or is predicted to fall, at the locations for each irrigation controller 318-326. When there has been a sufficient amount of rainfall at the location of an irrigation controller, when that irrigation controller is ready to commence a scheduled watering and checks in with the backend server 302, the backend server 302 will respond with a message indicating that the irrigation controller is to not water, and shift its watering schedule by an appropriate number of days, based on the recency of the rainfall. In response, the irrigation controller will not commence watering normally (but may commence special watering, such as for zones with recently laid sod), and will shift its normal watering schedule by the indicated number of days. This means that the irrigation controller never reverts to the previous schedule as it would have been but for the rainfall, and commences operation under the shifted schedule until and unless it is again shifted due to rainfall. When the irrigation controller's watering schedule is shifted due to predicted rainfall to occur on a day of scheduled watering, i.e. rainfall that hasn't yet happened when the irrigation controller checks in with the backend server 302, the watering schedule of the irrigation controller can be shifted by one day so that, on the next day the irrigation controller can check in with the backend server in case the predicted rainfall did not occur, and watering can be commenced, and thereafter the irrigation controller operates according to the shifted schedule which has been shifted by one day.

In the process of communicating with the various irrigation controllers 318-326 it is contemplated that over time, some of the irrigation controllers may become unresponsive. That is, an irrigation controller may experience a failure and be rendered unable to communicate. Failures that can cause such a condition can include, for example, sudden battery failures, circuit failures, breakage due to external causes, and so on. In order to ensure that the irrigation controllers 318-326 are functioning correctly, the backend server can maintain a status list of all irrigation controllers 318-326 which includes a record of communication. If a given irrigation controller 318-326 has not communicated on a scheduled watering day, then a system alert can be provided to an administrator or other suitable entity. The backend server 302 can generate a list or lists of all irrigation controllers 318-326 that have failed to communicate. Lists of failed irrigation controllers can be based on geographic areas such as zip code regions, or more granular areas such as specific addresses, parks, or other geographic divisions. The identity of the failed irrigation controllers can be provided to service personnel so that they can perform service on the failed irrigation controller(s).

In some embodiments, as irrigation controllers 318-326 report their respective statues, the backend server 302 can identify any irrigation controllers 318-326 that report a battery charge status below a given threshold (which can be specified by the administrator of the irrigation controllers 318-326). Thus, every day, a list of irrigation controllers 318-328 with low battery status can be provided to the administrator so that service personnel can then perform service on the listed irrigation controllers.

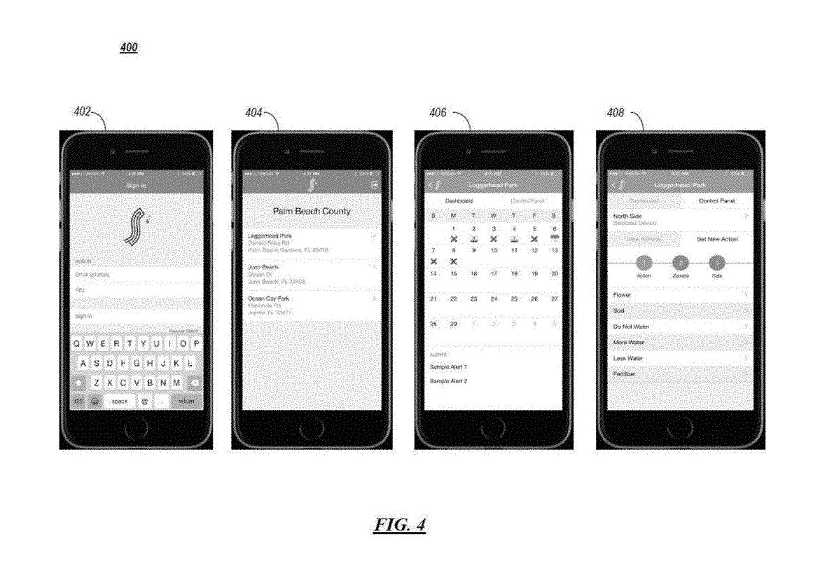

FIG. 4 is sequence diagram of an interface sequence 400 operated on a mobile device for interfacing and controlling operation of one or more battery powered networked irrigation controllers, in accordance with some embodiments. The mobile device illustrated here can be substantially similar to mobile devices 334, 340 of FIG. 3, and is used by a person to log into an account 402, view and interact with account information 404, see historical operation information 406, and utilize a provisioning interface 408 for an irrigation controller. The mobile device can use a commercially available browser application program or a similar proprietary application to access the information that is served by a backend server. The backend server maintains information for each account and irrigation controller, and responds to requests and makes changes in accordance with user input.

In the log in screen in interface 402 the mobile device is served an interface that prompts the user to input authentication information such as a user name, email address, and a personal identification number (PJN) or password. Once entered, the log in information is transmitted to the backend server for authentication. Interface 404 shows an example of a web page that can be served in response to a successful log in, and show the names of several locations where the user has set up irrigation systems using irrigation controllers (e.g. such as irrigation controller 200). Each of these locations can be clickable, and when clicked (or tapped), a new page specific to the clicked location can be served. Interface 406 shows historical operational information in a calendar format for a specific location, which can also be for a specific irrigation controller location. In the example shown, the user in interface 404 has selected “Loggerhead Park,” and in interface 406 a calendar for Loggerhead park is shown. In the calendar days when watering occurred as scheduled can be indicated by, for example, a sprinkler icon, such as on the 2^{nd} and 4^{th} days. Days where no watering occurred can be indicated with an “X” such as on the 1^{st}, 3^{rd}, 5^{th}, 7^{th}, and 8^{th} days. Days on which rainfall occurred can be indicated by a raincloud icon, such as on the 6^{th} day. Alert messages can be indicated or listed below the calendar (e.g. under “Alerts”), which each alert title being a hyperlink to an alert message interface, showing a message or messages regard the account, or some operational information regarding one or more irrigation controllers.

In interface 408, a page for provisioning a specific irrigation controller is shown rendered on the display of the mobile device. Several options for special watering operations are provided, such as “flower,” “sod,” “do not water,” “more water,” “less water,” and “fertilizer.” “Flower” can refer to an instance where landscape plants in a zone are flowering, and may need to be dry or go without water for several days, thus selecting that option will cause the irrigation controller to avoid watering in the selected zone(s) for a preselected number of days. “Sod” can refer to an instance where new grass sod has been laid in a zone, and needs to be well watered for several days in a row to allow the sod to become established. Accordingly, selecting the “sod” option causes the irrigation controller to water the indicated zone every day for a preselected number of days. The “do not water” option can cause the irrigation controller to skip watering for the selected zone(s). The “more water” and “less water” options can cause the irrigation controller to water longer or less on the days when watering occurs for the respective zones. The “fertilizer” option can be used when fertilizer is put down on landscaping, and watering is needed for that zone for one day, in addition to watering on other scheduled days.

In general, when the user selects an option and provides input, any changes to be made are stored at the backend server and formatted into a message that is relayed to the specific irrigation controller when the irrigation controller checks in prior to commencing a scheduled watering event. Those skilled in the art will appreciate that numerous variations in the specific design of interfaces can be produced which can all accomplish substantially similar functions.

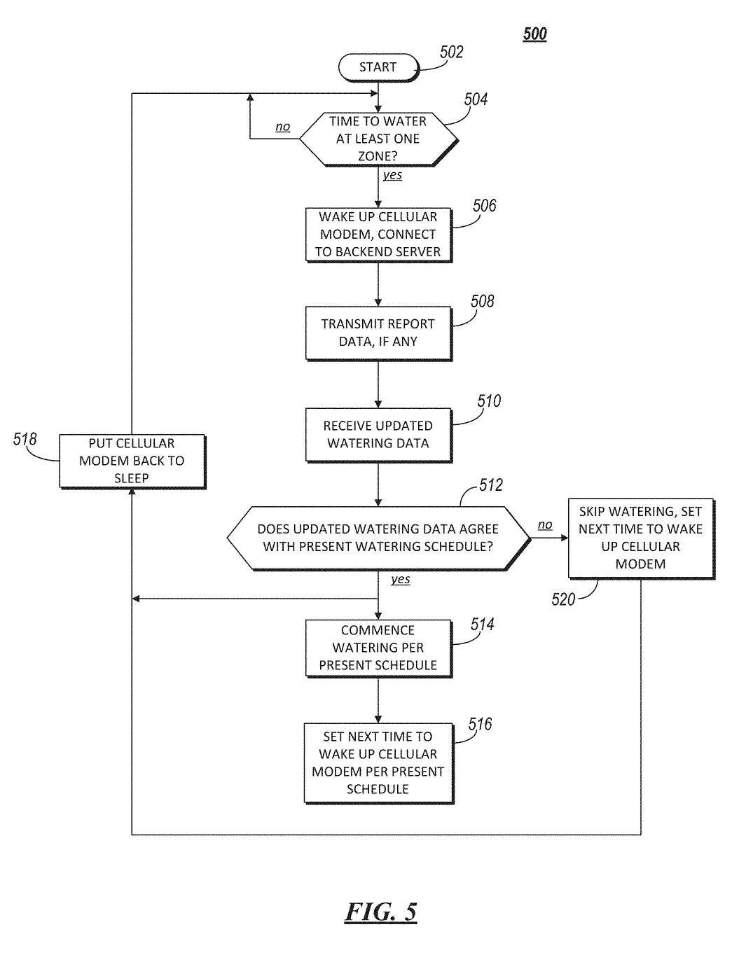

FIG. 5 is a flow chart diagram for a method 500 of operating a battery powered networked irrigation controller, in accordance with some embodiments. The method can be performed by an irrigation controller designed in accordance with irrigation controller 200 of FIG. 2. At the start 502, the irrigation controller is operating its processing unit, but the cellular transceiver modem is in a powered off or down state, consuming very little, if any, battery charge. The processing unit maintains a time of day and date clock, and there is a schedule record stored in a memory or data store of the irrigation controller. The schedule indicates the day and time of day at which the irrigation controller is to next commence watering, as well as the duration of watering (e.g. in minutes). The watering can be the same for all zones of the irrigation controller, or one or more zones may be watered while others are not, depending on whether there are any special circumstances for any of the zones, such as sod being laid, fertilizing, or flowering occurring in a zone or zones, which are reflected by input made by a user of the networked irrigation system for the specific irrigation controller. In step 504 the processing unit determines whether it is time to commence watering as indicated by the locally maintained schedule. The process of step 504 is shown as a loop, but it can be implemented in any of several ways, including as a background process that interrupts the processor when the scheduled time has been reached.

Once the time to commence watering has been reached, the method 500 proceeds to step 506 where the processing unit of the irrigation controller wakes up the cellular transceiver modem, and uses it to connect to the backend server. As previously described, the backend server can be reached using a unique URL that includes the domain of the backend server. Once a session with the backend server is established, the irrigation controller can transmit any status or other information it may have in step 508, such as, for example, a low battery alert, an indication that the irrigation controller was operated under local control (e.g. by maintenance personnel), and so on. In some embodiments the irrigation controller can be configured to always communicate a status update, including a status of the battery, in this step. This information, if provided, is stored by the backend server in association with the record for the irrigation controller so that alert messages and other information can be sent to the administrator or other supervisory authority of the irrigation controller. In some cases the information is merely kept for display the next time a user logs in to check on the system, and in more urgent cases, such as when there is a low battery alert, the backend server can generate a text message or email so that timely action can be taken.

In step 510 the backend server transmits any updates or changes to the watering schedule, including those that may inhibit watering that was scheduled to commence after this communication with the backend server. While the irrigation controller maintains its cellular transceiver modem in the powered off state for several days, rain may occur at the location of the irrigation controller, which will be determined by the backend server based on rainfall information from weather sources (e.g. NOAA, WMD). Thus, when rainfall has occurred, or is predicted to occur on the day of the communication, the backend server indicates a number of days that the irrigation controller is to shift its watering pattern. So, for example, if the watering pattern is to water once every three days, and it rained the day before at the location of the irrigation controller, the message from the backend server will be such that the irrigation controller will not water on the present day, and shift its watering pattern/schedule by two days. In general, if the irrigation controller commences normal watering every “n” days, where n is 2 or more, then the watering pattern is shifted by “n−r” days, where “r” is the number of days since the most recent rainfall at the location of the irrigation controller. Of course, when special watering in one or more zones of the irrigation controller is set to occur, such as to water every day in a zone where sod was recently laid, then watering will commence in those zones, but the normal daily watering pattern will be shifted so that either rain or watering occurs once every n days. Accordingly, in step 512, the irrigation controller evaluates any message received from the backend server to determine whether it is to commence with the scheduled watering according to the schedule it has, or whether it is to not water and shift the schedule by a number of days (1 to n−1 days).

When the backend server responds with a message as a result of recent rainfall, the method 500 proceeds to step 520 where the irrigation controller does not perform a general watering (special watering such as for a recently sodded zone can still occur), and the irrigation controller shifts its normal watering pattern/schedule by a number of days based on the message from the backend server received in step 510. If no special daily watering (e.g. for new sod) is to be commenced, then steps 506-510 are only carried out once every n days. Then in step 520 the currently scheduled general watering (i.e. that triggered the ‘yes” path out of step 504) is inhibited and the general watering schedule or pattern is shifted by n−r days. If watering is occurring daily, or more frequently than the general watering period, for one or more zones, then steps 506-510 can be carried out each of those days as well. For example, if rainfall is predicted to occur on a day on which watering is scheduled to occur, for special or general watering, the irrigation controller can inhibit watering for the present day, and can perform steps 506-510 the next day in case the predicted rainfall did not occur on the prior day as predicted. The method 500 then proceeds from step 520 to step 518 where the cellular transceiver modem is placed back into the off or low power state.

When, in step 512, no rainfall has occurred since the last watering, the method 500 proceeds to step 514 and the irrigation controller commences watering as scheduled. Prior to commencing watering in step 514, however, the irrigation controller can also proceed to step 518 to place the cellular transceiver modem back into the low power/off state. In step 516 the irrigation controller sets the next scheduled watering, which can be a next general watering or the start of a special water schedule for one or more zones, based on information received in step 510. Steps 514 and 516 can be reversed or performed concurrently, and once both are completed the method will resume at step 504 the next day.

Method 500 as exemplified here gives an overview of the principles of operation of the irrigation controller, based on information is receives from the backend server. Special watering events aside, the irrigation controller will be programmed or set to water every several days. Prior to starting watering on a scheduled watering day, the irrigation controller powers up its cellular transceiver mode to communicate with the backend server, which monitors rainfall at the location of the irrigation controller. If rainfall has occurred on a day since the last time the irrigation controller carried out a general watering, the backend server informs the irrigation controller to shift its general watering schedule by a number of days so that the general watering or rain fall occurs every n days, so that watering does not occur more than once every n days. In this way water is not wasted, and natural rainfall supplements irrigation. In the event that, upon attempting to contact the backend server, the irrigation controller is unable to make contact (within a preselected number of attempts or over a preselected time period, or due to battery failure), it can default to a conventional watering schedule of performing a general watering every three (or ‘n’) days until and unless it is able to again make contact with the backend server. In some embodiments the irrigation controller can attempt to connect with the backend server at regular periods that occur more frequently than that at which the general watering is to occur (e.g. every day).

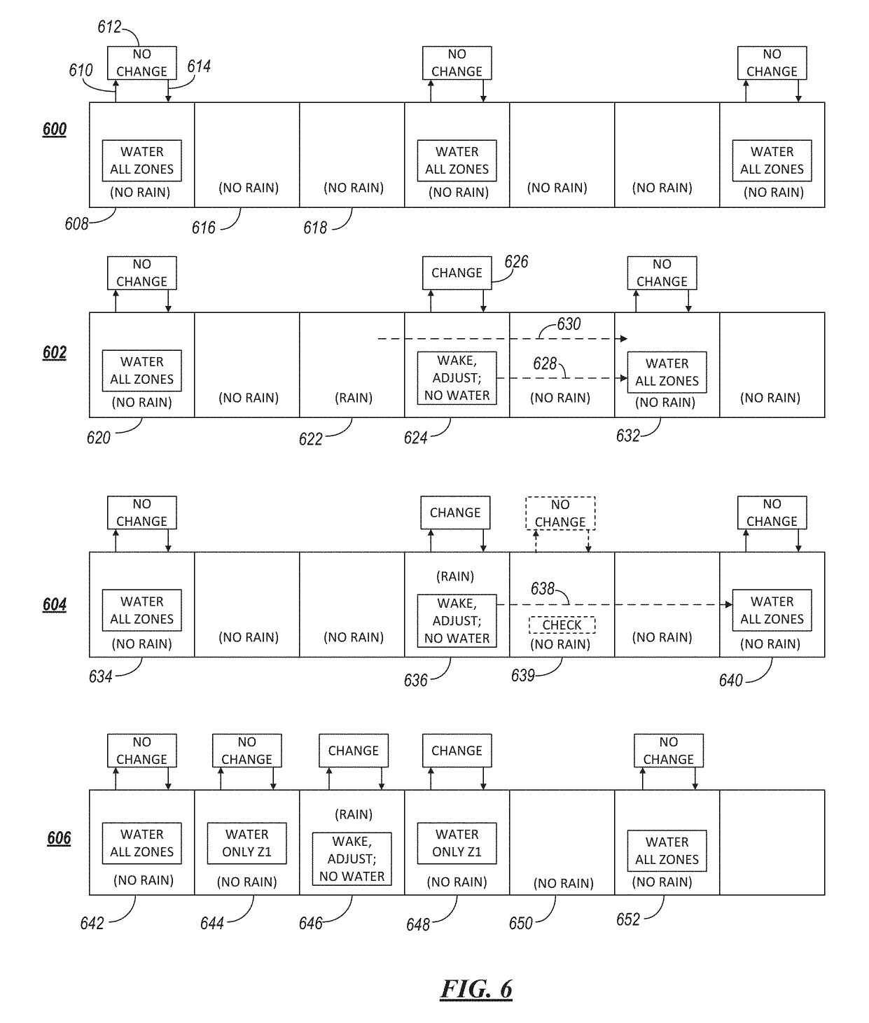

FIG. 6 is a scenario diagram showing several exemplary modes of operation of a battery powered networked irrigation controller, in accordance with some embodiments. The irrigation controller is designed in accordance with irrigation controller 200 of FIG. 2, and performs a method equivalent to method 500 of FIG. 5. Scenarios 600, 602, 604, and 606 each assume that the irrigation controller is set, scheduled, or otherwise programmed to commence general watering every third day, starting on the first day in each scenario, and each scenario shows seven days of operation.

Scenario 600 shows operation when no rainfall occurs for the seven days. On the first day, day 608, watering is scheduled to occur, so the irrigation controller powers up the cellular transceiver modem and contacts the backend server, indicated by line 610 (and all similar outgoing lines hereafter in FIG. 6). Since there has been no rain, the backend server formulates a message 612 that indicates no change to the schedule is to be made. The backend server then transmits the message 612 to the irrigation controller as indicated by line 614 (all incoming lines like 614 indicate messages transmitted to the irrigation controller in FIG. 6). Once the message is received the cellular transceiver can be shut off and watering is commenced in all zones. On days 616 and 618, no rain falls at the location of the irrigation controller. Since no rain occurs in scenario 600 then, this pattern is repeated every three days. Thus, the day after day 618 a general watering occurs, and again three days later in the last day of scenario 600.

Scenario 602 illustrates how the general watering schedule is shifted due to rainfall. On day 620, like on day 608 of scenario 600, a general watering occurs for all zones. However, on day 622 rain falls at the location of the irrigation controller. Accordingly, on day 624, the backend server formulates a message 626 that indicates a change is to be made. In response to message 626, the irrigation controller does not perform a watering (as indicated by “no water”). Since the rain fell on day 622, one day before the scheduled watering, the watering schedule is shifted to the third day after the rainfall, as indicated by line 630. Thus, the irrigation controller shifts the general watering schedule by two days, as indicated by line 628, to day 632. Assuming no rain falls on day 624 or the day between day 624 and day 632, the irrigation controller will perform a general watering upon receiving a message from the backend server indicating no change to the schedule, and the schedule will repeat again in three days (which is beyond the end of scenario 602).

Scenario 604 shows operation when rainfall is predicted to occur on a day on which watering is scheduled to occur. On day 634 a normal watering occurs, as on day 608 of scenario 600. No rain falls on the subsequent two days after day 634. On day 636, the third day after day 634, prior to the scheduled watering the irrigation controller powers up its cellular transceiver modem to communicate with the backend server. Since rain is predicted to fall on day 636 at the location of the irrigation controller, the backend server formulates a change message on the assumption that the predicted rain will fall, obviating the need to water. Accordingly, the next scheduled watering is then shifted to day 640, which would have been a scheduled watering day without any rain, as in scenario 600. However, the irrigation controller can, on day 639, check in with the backend server to verify that the predicted rain did in fact occur. If the predicted rainfall did occur, then the irrigation controller does not water and will not wake up its cellular transceiver modem again until day 640 when the next scheduled watering is to occur. If the predicted rain did not occur on day 636, then the backend server on day 639 would inform the irrigation controller to perform a general watering, and shift the watering schedule so that the next scheduled general watering occurs the day after day 640.

Scenario 606 shows special watering procedures along with general watering. Specifically, on days 642 and 648 a general watering is scheduled to occur, and on days 644 and 646 special watering for zone 1 is to occur in addition to being watered on the general watering days 642, 648. The special watering days can be set up by a message from the backend server on a day prior to day 642 (or on any day on which any watering is scheduled to occur). On day 642 a general watering of all zones is commenced, and no change is indicated in the communication with the backend server. On day 644 only zone 1 is scheduled to be watered. After communicating with the backend server the irrigation controller receives a message indicating there is no change, so zone 1 (and only zone 1) is watered on day 644. Again on day 646 zone 1 is scheduled to be watered. However, on day 646 rain is predicted to fall at the irrigation controller, and accordingly the backend server indicates a change to not perform any watering. On day 648, zone 1 is again scheduled to be watered, and the other zones would also be watered if no rain fell on day 646 as predicted. Thus, when the irrigation controller communicates with the backend server on day 648, and the predicted rainfall did occur on day 646 (and no rain is predicted on day 648), the message from the backend server is such that the irrigation controller waters only zone 1 on day 648 and shifts the next scheduled general watering to three days after the last day on which rain fell (e.g. day 646) to day 652. Day 648 is the last scheduled special watering day, so no watering at all occurs on day 650. On day 652 a general watering occurs as there has been no rain for the previous two days.

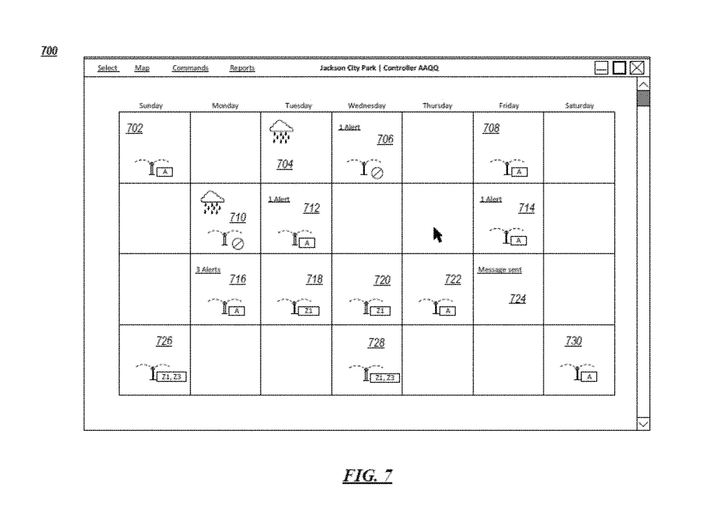

FIG. 7 is an interface diagram 700 showing a month-view of historical operation of a battery powered networked irrigation controller, in accordance with some embodiments. The diagram 700 can represent a window or tab of a browser that has is used to access a backend server from a computer on which the browser is instantiated. The window can show the account and specific irrigation controller at the top (“Jackson City Park Controller AAQQ”), and present menu selections (e.g. “Select,” “Map,” “Commands,” and “Reports.”). The month is shown in a seven day week by four week format, starting on Sunday each week. General watering is set to occur every third day if no rain falls at the location of the irrigation controller. Again, the irrigation controller is designed in accordance with that of FIG. 2, and operates substantially in accordance with method 500.

On day 702 the irrigation controller was programmed or scheduled to perform a general watering, and was not changed or adjusted by the backend server. Accordingly, on the space representing day 702 a sprinkler icon is shown, with a “A” to indicate all zones were watered. On day 704 rain falls at the location of the irrigation controller.

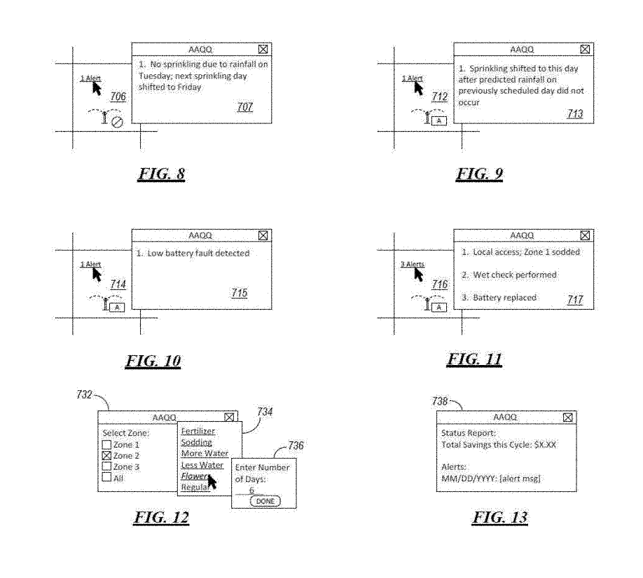

On day 706 the irrigation controller was programmed to perform a general watering as a result of communicating with the backend server on day 702. However, because ran fell on day 704, when the irrigation controller communicates with the backend server prior to commencing watering on day 706, the irrigation controller receives a command from the backend server to not water on day 706, and set the next watering day to be day 708, which is three days after day 704 when it rained. To inform the user that this change occurred, an alert message is indicated with a hyperlink “1 Alert.” FIG. 8 shows an example of what can be presented to the user upon clicking on the hyperlink, where an alert pop-up window 707 is presented with a message indicating that rain fell on the prior day and that the watering schedule has been shifted so that the next scheduled watering is Friday, which is three days after it rained on Tuesday.

On day 710, which is the third day after day 708, the irrigation controller is set to perform a general watering. However, upon communicating with the backend server, because it is predicted to rain at the location of the irrigation controller, the backend server responds with a message to not water, and that the irrigation controller is to again communicate with the backend server the next day to verify that the predicted rainfall did occur. Thus, on day 710, the sprinkling icon is showed with a circle with a diagonal line through it, indicating no watering occurred. However, in the example, no rain actually fell on day 710. As a result, the next day, on day 712, when the irrigation controller communicated with the backend server again, it received a message to perform the general watering, and set the next general watering day for three days later, on day 714. The alert hyperlink on day 712, when clicked, is shown in FIG. 9, where pop-up window 713 is displayed with a message informing the user that watering occurred on this day because rain predicted for the prior day, which was a scheduled general watering day, did not occur.

On day 714, which is three days after day 712, a general watering is set to occur. However, the irrigation controller detected a low battery charge condition. As a result, when the irrigation controller communicated with the backend server, it transmitted the low battery status, and in response the backend server generated an alert message for the user. The alert hyperlink on day 714, when clicked, is shown in FIG. 10, where a pop-up message 715 indicates the low battery condition. Additionally, because a low battery condition needs immediate attention, the backend server can be configured to send an email and/or a text message to one or people associated with the irrigation controller.

On day 716, which is the third day after day 714, with no rain falling between those days, a general watering is set to be performed. On this day there are three alert messages, as indicated by the alert hyperlink. Upon clicking the alert hyperlink on day 716, as shown in FIG. 11, a pop-up window 717 is displayed to the user. The alert messages indicate that zone 1 has been sodded, and this message was generated by local access at the irrigation controller (e.g. via a local wireless or wired interface of the irrigation controller). Furthermore, a wet check was performed to verify proper watering operation (e.g. sprinkler heads), and that the battery was replaced. The icons on days 712, 714, and 716 all indicate that all zones were watered. Since zone was sodded, on days 718, 720, special watering occurs where only zone 1 is watered, as indicated by “Z1” in the box next to the sprinkler icon. Day 722 is the third day after day 716, so the irrigation controller performed a general watering of all zones.

On day 724, the user used the interface to set up a change in watering, as shown in FIG. 12. A menu 732 allows the user to select one or more zones, and then to indicate what special watering type is to occur in box 734. In this example, the user has selected zone 2, and indicated that there is flowing occurring, and in box 736 the user indicates the number of days the special watering is to last (six days). As previously mentioned, for flowing plants, no watering is performed. Thus, on day 726, which is the third day after day 722, the irrigation controller, when it communicates with the backend server, receives a message indicating that no watering is to be performed in zone 2 for a period of six days. Thus, the icon on day 726 indicates watering was performed in zones 1 and 3, implying that no watering occurred in zone 2. Again on day 728, when a general watering would occur being the third day after day 726, only zones 1 and 3 are indicated as having been watered. On day 730, which is beyond the six days selected for zone 2, and which is the third day after day 728, a general watering of all zones is performed.

The user can also see a monthly status report 738, as indicated in FIG. 13, via one of the menus at the top of the window. In particular, the status report can indicate a monetary savings achieved by use of the inhibit and shift approach to scheduling watering in accordance with embodiments of the inventive irrigation controller and networked irrigation system. The report 738 can also present a summary of alert messages and the days on which they occurred, which can be hyperlinks that, when clicked, bring up pop-up boxes such as boxes 707, 713, 715, and 717.

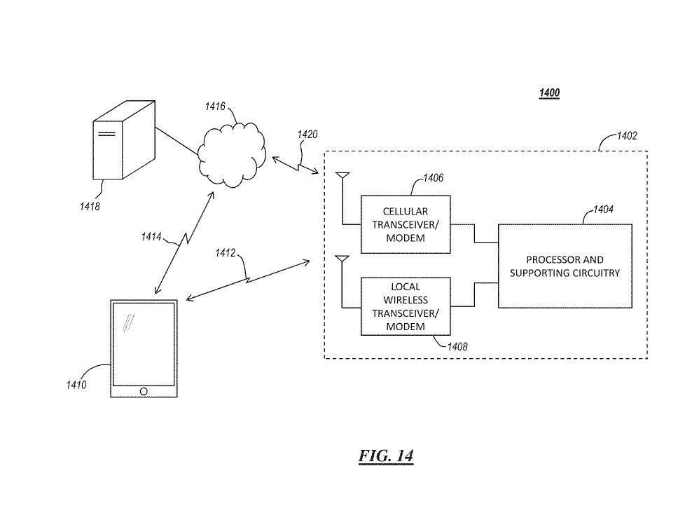

FIG. 14 shows an irrigation system 1400 in which an irrigation controller 1402 in low power mode can be reprogrammed prior to its next scheduled wake up time, in accordance with some embodiments. The irrigation controller 1402 is a networked wireless irrigation controller such as irrigation controller 102 of FIG. 1 and includes a processor 1404 that operates according to instruction code to operate a sprinkler/irrigation system at a location. The irrigation controller 1402 is battery powered, meaning it has no connection to a commercial electric service. The processor 1404 is operably coupled to a cellular transceiver/modem 1406 and a local wireless transceiver/modem 1408, both of which operate according to established radio communication protocols. For example, cellular transceiver/modem 1406 can operate using a data communication protocol such as LTE. The local wireless transceiver/modem can operate according to WiFi or BlueTooth protocols.

In operating, the irrigation controller 1402 operates one or more watering zones according to a watering schedule, which can be adjusted based on rainfall at the location of the system 1400. Because the irrigation controller is battery powered, and because most of the time it is not doing anything, the various components of the irrigation controller, in particular the cellular transceiver/modem 1406, are put to sleep, powered off, essentially, and therefore inoperative. In operation, a clock associated with processor 1404 allows the irrigation controller 1402 to operate according to a schedule. Upon the occurrence of a scheduled watering time, the processor 1404 wakes up the cellular transceiver/modem 1406 to communicate via a network 1416 with a remote scheduling server 1418. The server 1418 can confirm or adjust the watering schedule based on whether there has been rainfall at the location of the irrigation controller 1404. That means that the irrigation controller will commence watering according to schedule, unless the remote server 1418 instructs the irrigation controller 1402 to shift its watering schedule. If the irrigation controller 1402 is instructed to shift its watering schedule, then it will go back into the sleep mode until the next scheduled watering time.

However, if the horticultural conditions in the area irrigated by the irrigation controller 1404 change, until the irrigation controller 1404 wakes up at the next scheduled watering time the irrigation controller 1404 would not normally receive an updated watering schedule for the changed horticultural conditions. For example, if new sod is laid, then it is necessary to water frequently to facilitate the grass becoming rooted and established. If the sod is laid on a day on which watering occurred, after the irrigation controller has performed the watering, then the next watering may not be scheduled to occur for several days. At that time, several days after the sod has been laid, the irrigation controller will wake up normally and receive an updated schedule to water every day.

To avoid that problem, as mentioned in regard to FIGS. 1 & 2, a local device 1410, such as a cellular telephone device, or similar mobile computing device, can communicate directly with the irrigation controller 1402 through the local wireless transceiver/modem 1408. Although the irrigation controller 1402 can be placed into a sleep state, the local wireless transceiver/modem can periodically check to determine if a signal (e.g. an appropriate signal intended for the irrigation controller) is being received. Upon detecting a signal from the mobile device 1410, then a wireless link 1412 can be established between the mobile device 1410 and the local wireless transceiver/modem 1408. Such operation can be conventional, according to the personal area network protocol known as Bluetooth. The mobile device 1410 can be used to change the watering schedule so that, for example, new sod can be watered daily. Similar changes can be made if fertilizer is put down, or if less watering is desired for flowering species, and so on.

However, because the local access may not be authorized, the irrigation controller 1402, in response to the connection at the local wireless transceiver/modem 1408, can wake up the cellular transceiver/modem 1406, and contact the server 1418 using a radio communication link 1420 with a cellular station, included here in network 1416, which can also include internet and other data communications connectivity. Likewise, the mobile device 1410 can also communicate with the server 1418 as an authorized user over communication link 1414 to send the updated schedule or schedule changes to the server, and identifying irrigation controller 1402. That is, a user of the mobile device 1410 can access the server 1418 using an application program or browser running on the mobile device 1410 that allows the user to provide authentication credentials (e.g. user name and password), and then access the record for the irrigation controller 1402 to indicate watering schedule changes. The server 1418, having received the authorized changes, can then update the watering schedule it has for irrigation controller 1402. Upon the irrigation controller 1402 accessing server 1418 (or its equivalent), the server 1418 can then transmit or confirm the updated watering schedule.

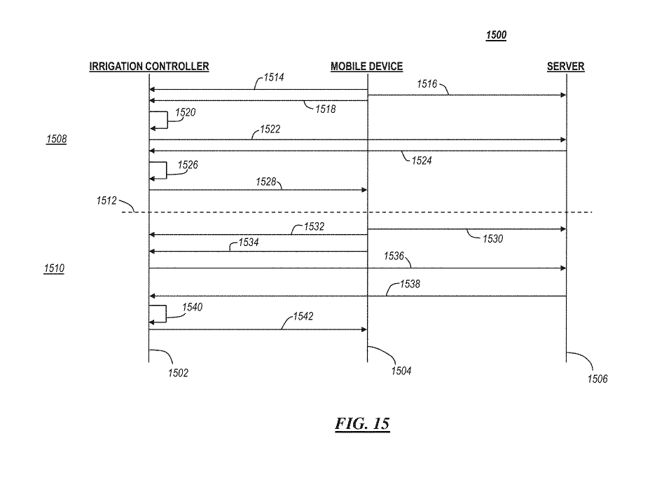

FIG. 15 is a signal flow diagram 1500 showing examples of methods for reprogramming a wireless irrigation controller that normally operates in a sleep mode until a scheduled watering time, in accordance with some embodiments. The methods described can be performed using the systems of FIGS. 1, 2, and 14, among others. The signals described herein refer to messages and communications between an irrigation controller, a mobile device, and a server, as represented by vertical lines 1502, 1504, and 1506, respectively. Two general methods, represented by a first method for section 1508 and a second method for section 1510, separated by line 1512, generally include the mobile device contacting server to indicate schedule changes for the irrigation controller, and also the mobile device communicating with the irrigation controller, followed by the irrigation controller communicating with the server.

In the first method 1508, the mobile device initiates communication with the irrigation controller in communication 1514, which can be, for example, the mobile device establishing a link over a Bluetooth connection (or similar) with the irrigation controller. The mobile device also communicates with the server in message 1516 to indicate the changes to the watering schedule for the irrigation controller. Message 1516 can be transmitted before the initial communication 1514 with the irrigation controller. In message 1518 the mobile device communicates the schedule change to the irrigation controller, and the irrigation controller stores the proposed schedule change as indicated by line 1520. In response to receiving the proposed schedule from the mobile device in message 1518, the irrigation controller then power on its cellular transceiver and communicates with the server, sending in a conformation request in message 1522. Message 1522 can contain the proposed schedule, or a portion or derivative thereof, to allow the server to determine that it is the same as that communicated or indicated in message 1516. The server then confirms the schedule changes in message 1524. Upon receiving the confirmation in message 1524, the irrigation controller can then adopt the proposed schedule as the active schedule, as indicated by line 1526, and in message 1528 the irrigation controller can confirm to the mobile device that the proposed schedule has been confirmed. After communication 1524 the irrigation controller can place its cellular transceiver back into the sleep/low power mode. Thereafter, the irrigation controller operates in accordance with the new watering schedule, rather than having to wait until the next scheduled watering time to obtain an updated schedule.

For example, assume that the irrigation controller controls watering in a plurality of zones, and is scheduled to next commence watering in two days. But on the present day workers have placed new sod in one of the zones. In messages 1516, 1518 a mobile device can be used to adjust the watering schedule from every three days, for example, for all zones, to every day for the newly sodded zone, and every three days for the other zones. After confirming the proposed changes, i.e. in messages 1522, 1524, the irrigation controller will then commence watering the sodded zone every day, and the other zones every third day. However, as in the method of FIG. 5, every day, for the next several days for which the new sod needs to be watered, the irrigation controller will first check with the server to determine whether watering is needed or not (i.e. whether there was rain which obviates the need to water). The cellular transceiver is kept in the off/sleep/low power mode until it is needed to communicate with the server.

In the second method 1510, the mobile device can send schedule changes to the server in message 1530, then initiate communication with the irrigation controller in message 1532 to the local wireless transceiver of the irrigation controller. Once communication is established, in message 1534 the mobile device can request the irrigation controller contact the server to receive an updated watering schedule. Accordingly, the irrigation controller will then power on its cellular transceiver as it normally would upon the occurrence of a scheduled watering time, as shown, for example, in the method of FIG. 5, and request an update in message 1536 from the server. In response to message 1536, the server responds with message 1538 with the updated watering schedule. Then the irrigation controller, upon receiving the updated watering schedule, makes the updated watering schedule active, as indicated by line 1540. The irrigation controller can then confirm to the mobile device that the watering schedule has been updated in message 1542.

Both of the general methods 1508, 1510 will take a very short time to complete. Variations on these methods will occur to those skilled in the art, as well, and additional steps for security and other purposes may be implemented. In general, however, the mobile device is used to enter an updated watering schedule into the system. The updated watering schedule can be first transmitted to the irrigation controller or to the server, or both. The irrigation controller wakes up its cellular transceiver and communicates with the server to verify or obtain the updated watering schedule, and upon conformation, adopts the new watering schedule. Thereafter the irrigation controller places its cellular modem back into a sleep mode, and commences following the updated watering schedule.

Accordingly, the networked irrigation system and irrigation controllers provide the benefit of a rain responsive system that avoids watering when rainfall provides the desired watering, and ensures that watering does not occur more frequently than needed by shifting the days on which watering is to be performed, generally, in response to rainfall. Furthermore, by being battery powered, the irrigation controllers can be deployed easier and with less cost as no commercial electric power lines need to be installed and connected. By networking the irrigation controller using a cellular transceiver modem, operation of the irrigation controller can be administered automatically by a backend server in correspondence with settings provided by supervisory personnel. Special watering schedules, which are temporary deviations from the regular watering schedule, can be implemented on site to take effect immediately by connecting to the irrigation controller locally, and then having the irrigation controller download or verify an updated watering schedule for events like laying new sod. This avoids having the irrigation controller remain in a sleep mode until its next scheduled watering event to obtain the updated watering schedule. The networking is facilitated by a cellular transceiver modem, which is kept powered off all the time except just prior to commencing watering, to communicate with the backend server to report any status information, and receive any changes in the watering schedule. Using the inventive networked irrigation system, in accordance with the embodiments disclosed herein, significantly reduces operating costs in water used, as well as personnel hours.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. Furthermore, the term “battery powered” will be read to mean exclusively battery powered, having no commercial electrical power source or connection.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description as part of the original disclosure, and remain so even if cancelled from the claims during prosecution of the application, with each claim standing on its own as a separately claimed subject matter. Furthermore, subject matter not shown should not be assumed to be necessarily present, and that in some instances it may become necessary to define the claims by use of negative limitations, which are supported herein by merely not showing the subject matter disclaimed in such negative limitations.

We claim:

1. A method for updating a watering schedule for a battery powered irrigation controller having a cellular transceiver and a local wireless network transceiver, the irrigation controller being configured to commence watering events according to a watering schedule, and being further configured to maintain a cellular transceiver in a sleep mode until a scheduled watering event to communicate with a backend server to either verify that the watering event is to be commenced or that the watering schedule is to be shifted by one or more days as a result of rainfall at the location of the irrigation controller, the method comprising:
receiving, at the local wireless network transceiver, while the cellular transceiver is in the sleep mode, an indication of an updated watering schedule;
responsive to receiving the indication of the updated watering schedule, the irrigation controller powering up the cellular transceiver from the sleep mode;
further responsive to receiving the indication of the updated watering schedule, and after the cellular transceiver is powered on, using the cellular transceiver to communicate with the backend server regarding the updated watering schedule; and
the irrigation controller adopting the updated watering schedule.

2. The method of claim 1, further comprising, responsive to using the cellular transceiver to communicate with the backend server, powering down the cellular transceiver into the sleep mode.

3. The method of claim 1, wherein receiving the indication of the updated watering schedule comprises receiving a proposed watering schedule from a mobile device, and wherein adopting the updated watering scheduled comprises adopting the proposed watering schedule as the updated watering schedule.

4. The method of claim 1, wherein receiving the indication of the updated watering schedule comprises receiving the update watering schedule from a mobile device via the local wireless network transceiver, and using the cellular transceiver to communicate with the backend server comprises the irrigation controller confirming the updated watering schedule with the backend server.

5. The method of claim 1, wherein receiving the indication of the updated watering schedule comprises receiving an indication from a mobile device via the local wireless network transceiver that an updated watering schedule is available from the backend server, and using the cellular transceiver to communicate with the backend server comprises the irrigation controller fetching the updated watering schedule from the backend server.

6. The method of claim 1, further comprising, after using the cellular transceiver to communicate with the backend server regarding the updated watering schedule, the irrigation controller transmitting a confirmation message via the local wireless network transceiver to an entity that transmitted the indication of the update watering schedule to the irrigation controller that the updated watering schedule has been confirmed.

7. The method of claim 1, wherein using the cellular transceiver to communicate with the backend server includes transmitting status information indicating a status of the irrigation controller, and wherein the status information includes a battery status of a battery that is used to power the irrigation controller.

8. A battery powered irrigation controller, comprising:
a cellular transceiver;
a local wireless network transceiver;
a processor being configured to control the irrigation controller to, in a first operating mode:
commence watering events according to a watering schedule;
maintain the cellular transceiver in a sleep mode until an occurrence of a scheduled watering event;
wake up the cellular transceiver to communicate with a backend server to either verify that the watering event is to be commenced or that the watering schedule is to be shifted by one or more days as a result of rainfall at the location of the irrigation controller;
the processor being further configured to control the irrigation controller to, in a second operating mode:
receive, at the local wireless network transceiver, while the cellular transceiver is in the sleep mode, an indication of an updated watering schedule;
responsive to the indication of the updated watering schedule, power up the cellular transceiver from the sleep mode;
further responsive to the indication of the updated watering schedule, and after the cellular transceiver is powered on, use the cellular transceiver to communicate with the backend server regarding the updated watering schedule; and
adopt the updated watering schedule.

9. The battery powered irrigation controller of claim 8, wherein the processor is further configured to control the irrigation controller to, responsive to power down the cellular transceiver into the sleep mode subsequent to use of the cellular transceiver to communicate with the backend server regarding the indication of the updated watering schedule.

10. The battery powered irrigation controller of claim 8, wherein receiving the indication of the updated watering schedule comprises receiving a proposed watering schedule from a mobile device, and wherein adopting the updated watering scheduled comprises adopting the proposed watering schedule as the updated watering schedule.

11. The battery powered irrigation controller of claim 8, wherein receiving the indication of the updated watering schedule comprises receiving the update watering schedule from a mobile device via the local wireless network transceiver, and using the cellular transceiver to communicate with the backend server comprises the irrigation controller confirming the updated watering schedule with the backend server.

12. The battery powered irrigation controller of claim 8, wherein receiving the indication of the updated watering schedule comprises receiving an indication from a mobile device via the local wireless network transceiver that an updated watering schedule is available from the backend server, and using the cellular transceiver to communicate with the backend server comprises the irrigation controller fetching the updated watering schedule from the backend server.

13. The battery powered irrigation controller of claim 8, further comprising, after using the cellular transceiver to communicate with the backend server regarding the updated watering schedule, the irrigation controller transmitting a confirmation message via the local wireless network transceiver to an entity that transmitted the indication of the update watering schedule to the irrigation controller that the updated watering schedule has been confirmed.

14. The battery powered irrigation controller of claim 8, wherein using the cellular transceiver to communicate with the backend server includes transmitting status information indicating a status of the irrigation controller, and wherein the status information includes a battery status of a battery that is used to power the irrigation controller.

15. An irrigation system, comprising:
a plurality of battery powered irrigation controllers, each one of the plurality of battery powered irrigation controllers being exclusively powered by a battery and having a cellular transceiver capable of communicating over a network, and wherein each one of the plurality of battery powered irrigation controllers is configured to maintain the cellular transceiver in a sleep mode until a scheduled time;
a backend server that is coupled to the network;
wherein each one of the plurality of irrigation controllers is further configured to, upon the scheduled time, wake up the cellular transceiver and communicate with the backend server, wherein the communication indicates whether the irrigation controller is to commence a scheduled watering according to a prior watering schedule or to shift the scheduled watering in a new watering schedule; and
wherein the backend server is configured, upon being contacted by each one of the plurality of irrigation controllers, to either confirm the prior watering schedule or provide the new watering schedule.

16. The irrigation system of claim 15, wherein each one of the plurality of irrigation controllers is further configured to report a battery status at the scheduled time.

17. The irrigation system of claim 16, wherein the backend server is further configured to identify in a record a list of any one of the plurality of irrigation controllers that report a battery low battery status indicating a charge level below a preselected threshold.

18. The irrigation system of claim 15, wherein the backend server is further configured to identify in a record a list of any one of the plurality of irrigation controllers that fails to communicate with the backend server within a preselected time after the scheduled time for the one of the plurality of irrigation controllers.

19. The irrigation system of claim 18, wherein the backend server is further configured to indicate on the list a geographic location of each one of the plurality of irrigation controllers that fails to communicate with the backend server.

20. The irrigation system of claim 15, wherein each one of the plurality of irrigation controllers further comprises a wireless local network transceiver and is further configured to receive a command from a mobile device via the wireless local network transceiver and in response to the command is further configured to wake up the cellular transceiver and communicate with the backend server via the cellular transceiver.
